(19) United States
(12) Patent Application Publication
(10) Pub. No.: US 2025/0135340 A1
(43) Pub. Date: May 1, 2025

(54) VIRTUAL ENVIRONMENT DISPLAY METHOD AND APPARATUS

(71) Applicant: Tencent Technology (Shenzhen) Company Limited, Shenzhen (CN)

(72) Inventor: Chennan ZHANG, Shenzhen (CN)

(73) Assignee: Tencent Technology (Shenzhen) Company Limited, Shenzhen (CN)

(21) Appl. No.: 19/006,082

(22) Filed: Dec. 30, 2024

Related U.S. Application Data
(63) Continuation of application No. PCT/CN2023/131740, filed on Nov. 15, 2023.

(30) Foreign Application Priority Data
Dec. 23, 2022 (CN) 202211667362.7

(51) Int. Cl. A63F 13/5252; A63F 13/5258; G06T 19/00

(52) U.S. Cl. CPC A63F 13/5252; A63F 13/5258; G06T 19/003; A63F 2300/6669; A63F 2300/6684

(57) ABSTRACT

A virtual environment display method and apparatus is provided. In the method, a virtual object in a three-dimensional virtual scene moving along a preset trajectory is displayed. The preset trajectory includes a curved trajectory and a non-curved trajectory. The virtual object in a first viewing angle direction is displayed. The first viewing angle direction is an observation direction of a first virtual camera along the non-curved trajectory. The virtual object in a second viewing angle direction is displayed when the virtual object moves to the curved trajectory. The second viewing angle direction is an observation direction of a second virtual camera along the curved trajectory. When the virtual object switches from the curved trajectory to the non-curved trajectory, the display of the virtual object back to the first viewing angle direction is updated.

### RELATED APPLICATIONS

The present application is a continuation of International Application No. PCT/CN2023/131740, filed on Nov. 15, 2023, which claims priority to Chinese Patent Application No. 202211667362.7, filed on Dec. 23, 2022. The entire disclosures of the prior applications are hereby incorporated by reference.

### FIELD OF THE TECHNOLOGY

This disclosure relates to the field of virtual environments, including to a virtual environment display method and apparatus, a device, a medium, and a program product.

### BACKGROUND OF THE DISCLOSURE

In a side-scrolling virtual game, a movement path is usually set for a master virtual object in advance, and a player can participate in a virtual battle by controlling the master virtual object to move and attack along the movement path.

In the related art, a game picture displayed on a terminal is generally formed by using two-dimensional aesthetic resources. In other words, virtual resources in the game picture are all elements formed by two-dimensional maps.

However, as resources of the two-dimensional maps are limited, a sense of rhythm of a movement animation generated by moving the master virtual object is weak, and only a horizontal translation effect and a vertical translation effect can be achieved visually. A rich variety of visual switching effects cannot be presented, which not only affects rendering quality of the game picture, but also greatly lacks a three-dimensional effect.

### SUMMARY

Embodiments of this disclosure provide a virtual environment display method and apparatus, a device, a medium, and a program product, to implement more visual switching effects. Examples of technical solutions are as follows.

According to an aspect, a virtual environment display method is provided. In the method, a virtual object in a three-dimensional virtual scene moving along a preset trajectory is displayed. The preset trajectory includes a curved trajectory and a non-curved trajectory. The virtual object in a first viewing angle direction is displayed. The first viewing angle direction is an observation direction of a first virtual camera along the non-curved trajectory. The virtual object in a second viewing angle direction is displayed when the virtual object moves to the curved trajectory. The second viewing angle direction is an observation direction of a second virtual camera along the curved trajectory. When the virtual object switches from the curved trajectory to the non-curved trajectory, the display of the virtual object back is updated to the first viewing angle direction.

According to an aspect, an information processing apparatus is provided. The apparatus includes processing circuitry that is configured to display a virtual object in a three-dimensional virtual scene. The virtual object moves along a preset trajectory. The preset trajectory includes a curved trajectory and a non-curved trajectory. The processing circuitry is configured to display the virtual object in a first viewing angle direction. The first viewing angle direction is an observation direction of a first virtual camera along the non-curved trajectory. The processing circuitry is configured to display the virtual object in a second viewing angle direction when the virtual object moves to the curved trajectory. The second viewing angle direction is an observation direction of a second virtual camera along the curved trajectory. The processing circuitry is configured to update, when the virtual object switches from the curved trajectory to the non-curved trajectory, the display of the virtual object back to the first viewing angle direction.

According to an aspect, a computer device is provided. The computer device includes a processor and a memory, the memory having at least one instruction, at least one segment of program, a code set, or an instruction set stored therein, the at least one instruction, the at least one segment of program, the code set, or the instruction set being loaded and executed by the processor to implement the virtual environment display method according to any one of the foregoing embodiments of this disclosure.

According to an aspect, a non-transitory computer-readable storage medium is provided. The non-transitory computer-readable storage medium has at least one piece of program code stored therein, the at least one piece of program code being loaded and executed by a processor to implement the virtual environment display method according to any one of the foregoing embodiments of this disclosure.

According to an aspect, a computer program product or a computer program is provided, the computer program product or the computer program including computer instructions, and the computer instructions being stored in a computer-readable storage medium. A processor of a computer device reads the computer instructions from the computer-readable storage medium and executes the computer instructions, to enable the computer device to perform the foregoing virtual environment display method according to any one of the foregoing embodiments.

Technical solutions provided in this disclosure include at least the following beneficial effects.

In a process in which a virtual object, such as a master virtual object, moves according to the preset movement trajectory in the three-dimensional virtual environment, when the master virtual object passes through the curved trajectory of the preset movement trajectory, the first viewing angle direction in which the master virtual object is observed along the non-curved trajectory is switched to the second viewing angle direction in which the master virtual object is observed through synchronous rotation along the curved trajectory. In addition, when the master virtual object passes through the non-curved trajectory of the preset movement trajectory, the second viewing angle direction is flexibly switched to the first viewing angle direction in which the master virtual object is observed. A viewing angle of observing the master virtual object is switched, so that flexibility of controlling the master virtual object can be improved, and a movement status of the master virtual object in the three-dimensional virtual environment can be further vividly presented. More visual experiences are created according to the fixedly set preset movement trajectory, and the visual experiences are presented in a three-dimensional form. This further improves a visual impact effect on a user in a side-scrolling game, and improves interface expression of the three-dimensional virtual environment.

### BRIEF DESCRIPTION OF THE DRAWINGS

FIG. 1 is a schematic diagram of an implementation environment according to an example of this disclosure.

FIG. 2 is a flowchart of a virtual environment display method according to an example of this disclosure.

FIG. 3 is a schematic diagram of a change of a three-dimensional modeling interface according to an example of this disclosure.

FIG. 4 is a schematic diagram of a direction corresponding to a three-dimensional virtual object according to an example of this disclosure.

FIG. 5 is a diagram showing interface changes that corresponds to movement based on a curved trajectory according to an example of this disclosure.

FIG. 6 is a flowchart of a virtual environment display method according to another example of this disclosure.

FIG. 7 is a diagram showing interface changes that corresponds to movement based on a circular trajectory according to an example of this disclosure.

FIG. 8 is a schematic diagram of a circular trajectory of a virtual environment provided based on FIG. 7.

FIG. 9 is a schematic diagram of a trajectory corresponding to movement based on an irregular trajectory according to an example of this disclosure.

FIG. 10 is a flowchart of a virtual environment display method according to still another example of this disclosure.

FIG. 11 is a schematic diagram of a direction corresponding to a three-dimensional virtual object according to an example of this disclosure.

FIG. 12 is a schematic diagram of an interface corresponding to a side-scrolling camera according to an example of this disclosure.

FIG. 13 is a schematic diagram of a direction corresponding to a three-dimensional virtual object according to an example of this disclosure.

FIG. 14 is a structural block diagram of a virtual environment display apparatus according to an example of this disclosure.

FIG. 15 is a structural block diagram of a virtual environment display apparatus according to another example of this disclosure.

FIG. 16 is a structural block diagram of a terminal according to an example of this disclosure.

### DETAILED DESCRIPTION

To make the objectives, technical solutions, and advantages of this disclosure clearer, the following disclosure further describes aspects in further detail with reference to the accompanying drawings.

First, examples of nouns and terms used in the examples of this disclosure are provided.

A virtual environment is displayed (or provided) by an application when run on a terminal. In the embodiments of this disclosure, the application is implemented as a side-scrolling game. The virtual environment may be a simulated environment of the real world, or may be a semi-simulated semi-fictional three-dimensional environment, or may be an entirely fictional three-dimensional environment. The virtual environment may be any one of a 2.5-dimensional virtual environment and a three-dimensional virtual environment. A description is made by using an example in which the virtual environment is a three-dimensional virtual environment in the following embodiments, but this is not limited. In some embodiments, the virtual environment is further configured for a virtual environment battle between at least two virtual roles. In some embodiments, the virtual environment is further configured for a virtual environment battle between a master virtual object and another virtual object. In some embodiments, the virtual environment is further configured for virtual environment interaction between the master virtual object and three-dimensional virtual resources. In some embodiments, the virtual environment is further configured for a virtual environment battle/virtual environment interaction between the master virtual object and the another virtual object and between the master virtual object and the three-dimensional virtual resources in a game level. The three-dimensional virtual resources are configured for indicating three-dimensional objects that form the three-dimensional virtual environment, and include but are not limited to a three-dimensional barrier, a three-dimensional shelter, a three-dimensional staircase, a three-dimensional house, and the like.

The master virtual object is a controllable object in the virtual environment. The controllable object may be a virtual character, a virtual animal, a cartoon character, or the like, such as a character, an animal, a plant, an oil drum, a wall, or a stone displayed in a three-dimensional virtual environment. In some embodiments, the master virtual object is a three-dimensional model created based on a skeletal animation technology. The master virtual object has a shape and size in the three-dimensional virtual environment, and occupies some space in the three-dimensional virtual environment. The master virtual object is a virtual object body used/controlled by a player. The player can control the master virtual object to perform actions such as walking, running, jumping, shooting, combatting, driving, picking up an item, and using a skill in the three-dimensional virtual environment, and interaction is strong.

In the embodiments of this disclosure, in addition to the master virtual object, there are other virtual objects in the three-dimensional virtual environment. The three-dimensional virtual object and the other virtual objects may be in a hostile relationship, may be in a teammate relationship, or may be in no relationship. This is not limited in this disclosure.

In the related art, in the side-scrolling game, aesthetic resources of a two-dimensional map are configured for forming the entire virtual environment. When the player controls interaction such as movement of the master virtual object in the two-dimensional virtual environment, only movement such as upward movement, downward movement, leftward movement, and right ward movement can be performed. In other words, for a user, a virtual interface can only be synchronously translated with movement such as upward movement, downward movement, leftward movement, and rightward movement performed by the master virtual object. A visual experience of the user is largely limited by the resources of the two-dimensional map. This reduces an exploration capability of the user in the virtual environment.

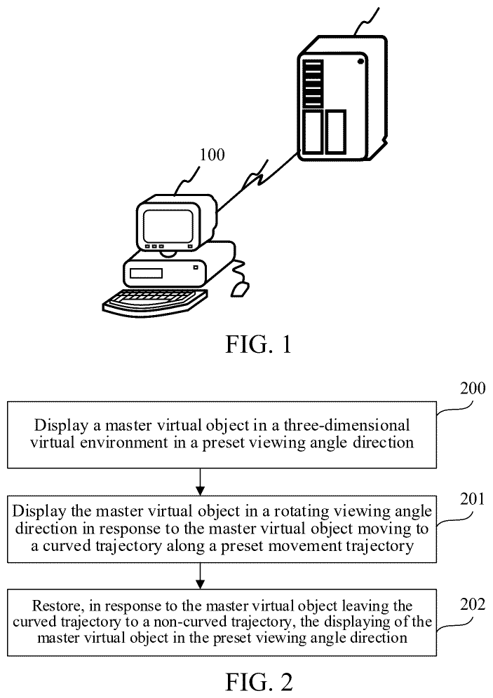

An implementation environment of the embodiments of this disclosure is described with reference to the foregoing term explanations. FIG. 1 is a structural block diagram of a computer system according to an example of this disclosure. The implementation environment includes a terminal 100, a server 110, and a communication network 120.

An application supporting a three-dimensional virtual environment is installed and run on the terminal 100. The application may be implemented as a side-scrolling virtual application. The terminal 100 is a device used by a user, and the user controls, through the terminal 100, a master virtual object in the three-dimensional virtual environment to perform an activity. The activity includes, but is not limited to, at least one of body orientation adjustment, crawling, walking, running, cycling, jumping, driving, picking, and shooting. The master virtual object may be a virtual character such as a simulated character role or a cartoon character role.

The terminal 100 is connected to the server 110 by using the communication network 120. A device type of the terminal includes at least one of a game console, a desktop computer, a smartphone, a tablet computer, an eBook reader, an MP3 player, an MP4 player, and a portable laptop computer.

The server 110 includes at least one of one server, a plurality of servers, a cloud computing platform, and a virtualization center. The server 110 is configured to provide background services for the application supporting the three-dimensional virtual environment. In some embodiments, the server 110 takes on primary computing work, and the terminal 100 takes on secondary computing work; the server 110 takes on secondary computing work, and the terminal 100 takes on primary computing work; or collaborative computing is performed by using a distributed computing architecture between the server 110 and the terminal 100.

In the embodiments of this disclosure, the user controls, through the terminal 100, the master virtual object to move according to a preset movement trajectory in the three-dimensional virtual environment (e.g., virtual scene). The preset movement trajectory includes a curved trajectory and a non-curved trajectory. When the user controls the master virtual object to walk to the non-curved trajectory, the master virtual object is displayed in a first viewing angle direction. The first viewing angle direction is a relative observation direction in which the master virtual object is observed along the non-curved trajectory. For example, the first virtual object indicates a virtual camera to display the master virtual object in an observation direction of translational movement. The translation movement includes upward translation, downward translation, leftward translation, and rightward translation. When the user controls the master virtual object to walk to the curved trajectory, the master virtual object is displayed in a second viewing angle direction. The second viewing angle direction is configured for indicating a relative observation direction in which the master virtual object is observed through synchronous rotation along the curved trajectory. When the user moves from the curved trajectory to the non-curved trajectory (leaves the curved trajectory), the displaying of the master virtual object in the first viewing angle direction is restored.

In some embodiments, whether in the first viewing angle direction or in the second viewing angle direction, when the master virtual object performs interaction in the three-dimensional virtual environment, the master virtual object may always be used as a center for displaying the three-dimensional virtual environment. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the embodiments of this disclosure, an example in which the virtual environment display method is applied to a side-scrolling game is used for description. The method may be further applied to an application such as a massive multiplayer online role-playing game, a multiplayer online battle arena game, a virtual reality application, a three-dimensional map program, or the like. This is not limited herein.

The user controls the master virtual object to perform activities in the three-dimensional virtual environment. The master virtual object needs to complete a preset task in a virtual battle, to ensure that the master virtual object survives to the end of the game. The preset task is configured for indicating a game task preset by a developer.

In the three-dimensional virtual environment, that the master virtual object performs a battle with another virtual object may be further included. The another virtual object may be a virtual object controlled by another user, or may be a non-player character (NPC) virtual object controlled by artificial intelligence (AI). Alternatively, in the three-dimensional virtual environment, that the master virtual object cooperates with the another virtual object to complete the preset task may be further included. This is not limited in this disclosure.

FIG. 2 is a flowchart of a virtual environment display method according to an example of this disclosure. In an embodiment of this disclosure, the method is performed by a terminal The method includes:
Operation 200: Display a master virtual object in a three-dimensional virtual environment in a first viewing angle direction.

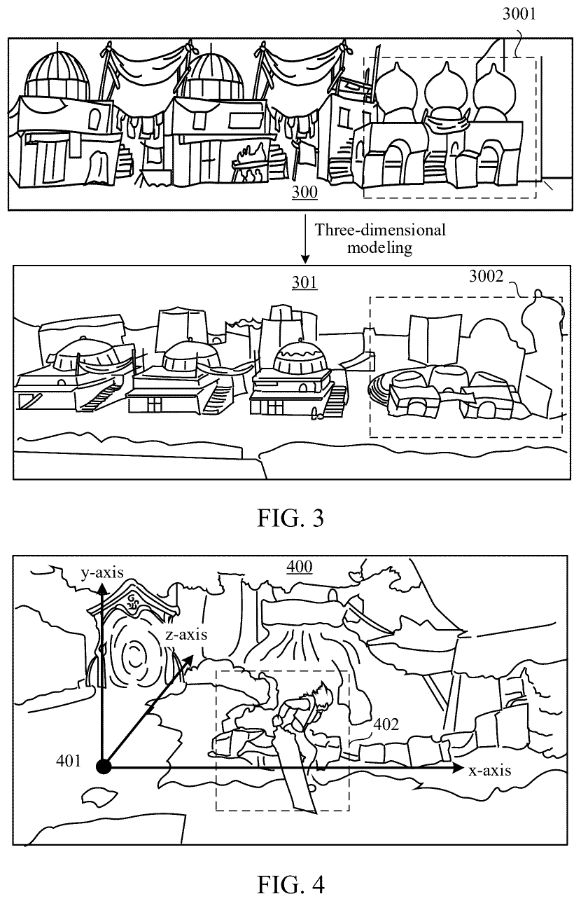

In the embodiments of this disclosure, original two-dimensional aesthetic resources are presented in a three-dimensional (3D) modeling form. For example, a virtual object in the two-dimensional artwork resources is presented in the 3D modeling form. As shown in FIG. 3, the virtual environment is displayed as a two-dimensional scene in a side-scrolling virtual program. The two-dimensional virtual environment 300 includes a two-dimensional house 3001. In the embodiments of this application, 3D modeling is performed according to appearance features of the original two-dimensional house 3001, to obtain a three-dimensional virtual environment 301. The three-dimensional virtual environment 301 includes a three-dimensional house 3002 corresponding to the two-dimensional house 3001. It is not difficult to learn from FIG. 3 that, in a two-dimensional virtual environment interface, the master virtual object can only move in a left direction or a right direction on a screen. However, in a three-dimensional virtual environment interface, an original two-dimensional map is implemented as a three-dimensional structure, and the master virtual object can move around the three-dimensional structure, to add more movement trajectories, and increase an exploration experience of a player.

In some embodiments, the entire virtual resources are determined in the foregoing 3D modeling manner, and the three-dimensional virtual environment is formed. In a case of original two-dimensional virtual resources, after a user controls the master virtual object to move only at an edge of the two-dimensional map, to form the three-dimensional virtual environment, a movement range of the master virtual object is increased to some extent. The player can control the master virtual object to move in an outline or a preset range of a three-dimensional object, to enrich viewing angle experiences more. In addition, after an object in the virtual environment is three-dimensionalized, more movement trajectories may be added, and a part of the three-dimensional object may be expanded, so that the master virtual object moves surrounding the three-dimensional object, or the master virtual object moves to the back of the three-dimensional object.

In some embodiments, the three-dimensional virtual environment includes the master virtual object. The master virtual object is an object controlled by the player, and can interact with the three-dimensional virtual resources in the three-dimensional virtual environment. The interaction includes moving, jumping, picking, and the like. In some embodiments, the three-dimensional virtual environment includes a virtual environment picture corresponding to at least one sub-level. In other words, a side-scrolling game includes at least one sub-level. Each sub-level corresponds to a three-dimensional virtual environment. Three-dimensional virtual resources included in each three-dimensional virtual environment are different/the same.

For example, in a two-dimensional virtual scene, movement control controls are displayed in an interface of a terminal, including a left movement control and a right movement control. The left movement control is configured to control the virtual object to move, according to a predetermined path, in a first direction, the right movement control is configured to control the virtual object to move, according to a predetermined path, in a second direction, and the first direction is opposite to the second direction. In this case, mapping to a three-dimensional virtual scene, movement control controls are displayed in an interface of a terminal, including a left movement control and a right movement control. The left movement control is configured to control the virtual object to move, according to a predetermined path, in a first direction, and the right movement control is configured to control the virtual object to move, according to a predetermined path, in a second direction. In the process of moving in the first direction and the second direction, due to the three-dimensional virtual scene, movement of the virtual object leads to a curved trajectory, and the user can still automatically move on an arch-shaped trajectory through the left movement control or the right movement control.

In the embodiments of this disclosure, the master virtual object moves along a preset movement trajectory in the three-dimensional virtual environment.

In some embodiments, a game background automatically plans the at least one preset movement trajectory for the master virtual object according to a terrain condition of the three-dimensional virtual environment. For example, the game background plans, according to a map of islands, a bridge connecting two lands as a preset movement trajectory, so that a movement trajectory of the virtual object moving in the three-dimensional virtual environment is more real. In some embodiments, the preset movement trajectory may be implemented as a preset linear movement trajectory, or may be implemented as a movement trajectory automatically generated as the master virtual object moves in a specific movement area. A generation range condition of the movement trajectory is the specific movement area. That is, the preset movement trajectory may be implemented as a trajectory generated in real time within limits of the specific movement area.

In some embodiments, during a virtual battle, the player sets at least one preset movement trajectory for the master virtual object. For example, before the game starts or during the game, a trajectory drawing interface is displayed by triggering a trajectory drawing control in the interface. The trajectory drawing interface is configured for the player to draw the preset movement trajectory. For example, the player draws a trajectory that a point A is connected to a point B in a straight line and the point B is connected to a point C in a curved line as the preset movement trajectory.

In some embodiments, the preset movement trajectory is configured for limiting a movement path of the master virtual object. For example, the master virtual object needs to move in a path range limited by the preset movement trajectory. The preset movement trajectory is implemented as a linear trajectory, a ribbon trajectory, or the like. For example, the master virtual object may continuously perform forward movement along the preset movement trajectory, or may continuously perform reverse movement along the preset movement trajectory, or may first perform forward movement along the preset movement trajectory and then perform reverse movement along the preset movement trajectory; or may first perform reverse movement along the preset movement trajectory and then perform forward movement along the preset movement trajectory. A movement distance of the forward movement and a movement distance of the reverse movement may be the same or different. This is not limited herein.

The preset movement trajectory includes a non-curved trajectory and a curved trajectory.

In some embodiments, the non-curved trajectory is configured for indicating a trajectory on which the master virtual object moves in a straight line in the three-dimensional virtual environment, and the curved trajectory is configured for indicating a trajectory on which the master virtual object moves in a curved line with a radian in the three-dimensional virtual environment.

In some embodiments, a trajectory segment on the preset movement trajectory whose average curvature is greater than a preset curvature is referred to as the curved trajectory, and a trajectory segment on the preset movement trajectory whose average curvature is less than or equal to the preset curvature is referred to as the non-curved trajectory. For example, a curvature is configured for representing a degree to which the curved line deviates from the straight line. The average curvature is used as content reflecting a change in an overall curvature of a trajectory, and may be defined as a ratio of an angle rotated by a tangent line along the trajectory to a length of the trajectory. For example, after the preset movement trajectory is determined (where the preset movement trajectory may also be determined in real time), an average curvature corresponding to each trajectory segment (for example, the preset movement trajectory is segmented with a specific trajectory length, and the trajectory segment may also be implemented as the preset movement trajectory) on the preset movement trajectory is determined, so that a trajectory segment implemented as the curved trajectory and/or a trajectory segment implemented as the non-curved trajectory on the preset movement trajectory are/is determined according to a value relationship between the average curvature and the preset curvature. The preset curvature is a curvature set by default in the game background. For example, the preset curvature is ⅛.

In some embodiments, a trajectory segment whose angle change amplitude between trajectory tangent lines respectively corresponding to two adjacent trajectory points on the preset movement trajectory is greater than a preset amplitude is referred to as the curved trajectory. A trajectory segment whose angle change amplitude between trajectory tangent lines respectively corresponding to two adjacent trajectory points on the preset movement trajectory is less than or equal to the preset amplitude is referred to as the non-curved trajectory.

For example, for any trajectory segment in a preset movement trajectory, an angle change amplitude between trajectory tangent lines respectively corresponding to two adjacent trajectory points is greater than the preset amplitude, which is considered as the curved trajectory. In other words, an angle change amplitude between trajectory tangent lines respectively corresponding to other two adjacent trajectory points is less than the preset amplitude, and the trajectory segment is also considered as the curved trajectory. Similarly, for any trajectory segment on a preset movement trajectory, an angle change amplitude between trajectory tangent lines respectively corresponding to any two adjacent trajectory points is less than or equal to the preset amplitude, which is considered as the non-curved trajectory, or the like. The preset amplitude is an amplitude set by default in the game background. For example, the preset amplitude is 5°. The foregoing content of determining the curved trajectory and the non-curved trajectory through the average curvature or the angle change amplitude as a determining parameter is only a schematic example. This is not limited in the embodiments of this disclosure.

In the embodiments of this disclosure, a trajectory line on which the master virtual object moves according to the preset movement trajectory in the three-dimensional virtual environment is referred to as a movement line. The movement line (the preset movement trajectory) includes a plurality of trajectory points. The trajectory points may be considered as points at which the master virtual object can move. The plurality of trajectory points forms the movement line.

The first viewing angle direction is a relative observation direction in which the master virtual object is observed along the non-curved trajectory.

For example, when the master virtual object moves in the three-dimensional virtual scene, a display status of the master virtual object is determined according to a current movement trajectory of the master virtual object. If the master virtual object moves along the preset movement trajectory, when the master virtual object is on the non-curved trajectory of the preset movement trajectory, for example, on a straight line trajectory or a curved trajectory with a small curved angle, the non-curved trajectory on which the master virtual object moves is used as a reference, and an observation viewing angle of a virtual camera configured for observing the master virtual object is adjusted, so that a movement status of the master virtual object relative to the non-curved trajectory is correspondingly displayed.

In some embodiments, the first viewing angle direction is configured for indicating a translation observation direction in which the master virtual object is observed. In the first viewing angle direction, a movement trajectory of the master virtual object is a straight line, or an angle of a tangent line that is of each trajectory point on the movement trajectory of the master virtual object and that is relative to a horizontal direction falls within a preset range. For example, the master virtual object moves in a horizontal direction or in a vertical direction in the three-dimensional virtual environment. During the movement, all trajectory points that the master virtual object passes through in the three-dimensional virtual environment are connected on a same horizontal line. In a process of observing the master virtual object, a viewing angle trajectory of the master virtual object that is obtained is parallel to a movement trajectory of the master virtual object.

Operation 201: Display the master virtual object in a second viewing angle direction in response to the master virtual object moving to the curved trajectory along the preset movement trajectory.

In some embodiments, when the player controls the master virtual object to move from the curved trajectory to the non-curved trajectory, the master virtual object is displaced in a longitudinal direction in the three-dimensional virtual environment. In other words, there is an angle of a preset degree between a tangent line of a trajectory point on the movement trajectory and a horizontal direction.

In the embodiments of this disclosure, from left to right is defined as a horizontal direction, namely, an x-axis, from bottom to top is defined as a vertical direction, namely, a y-axis, and from a foreground area to a perspective area is defined as a longitudinal direction, namely, a z-axis. In response to the movement of the master virtual object in the longitudinal direction, namely, the z-axis, the master virtual object is observed by switching the original first viewing angle direction to the second viewing angle direction.

In some embodiments, after the virtual resources in the virtual environment are implemented as three-dimensional aesthetic resources, the player may control the master virtual object to have a 3D game experience in a side-scrolling game. Because a concept of the longitudinal direction, namely, the z-axis, is introduced, when the master virtual object is controlled to move in the longitudinal direction, namely, the z-axis, a visual effect of walking into a screen of the terminal may be created for the player. FIG. 4 is a schematic diagram of an interface of a three-dimensional virtual environment according to an embodiment of this disclosure. In a virtual environment interface 400, a trajectory point 401 is used as a center, from left to right is defined as a horizontal direction, namely, an x-axis, from bottom to top is defined as a vertical direction, namely, a y-axis, and from a foreground area to a perspective area is defined as a longitudinal direction, namely, a z-axis. A player controls a master virtual object 402 to move in the three-dimensional virtual environment. In a general side-scrolling virtual game, even if three-dimensional virtual resources are set, a virtual camera only moves in the horizontal direction, namely, the x-axis and moves in the vertical direction, namely, the y-axis. For the player, a change in a virtual interface is still translation movement of upward movement, downward movement, leftward movement, and rightward movement, and there is no other visual switching possibility and experience. In this disclosure, while the longitudinal direction, namely, the z-axis is introduced, a movement trajectory of the virtual camera is maintained consistent with a movement trajectory of the master virtual object.

A second viewing angle direction is configured for indicating a relative observation direction in which the master virtual object is observed through synchronous rotation along a curved trajectory.

In some embodiments, in a process of observing the master virtual object, a viewing angle trajectory of the master virtual object is obtained, and the viewing angle trajectory is controlled to be parallel to the movement trajectory of the master virtual object. For example, when the master virtual object performs rotational movement in the three-dimensional virtual environment in a radian corresponding to the curved trajectory, a viewing angle direction of the master virtual object is obtained, and the viewing angle direction is also controlled to perform rotational observation with the radian.

In an example, a plurality of trajectory points on the curved trajectory are determined in a process in which the master virtual object moves according to the curved trajectory. The trajectory point corresponds to a position of the master virtual object in the three-dimensional virtual environment.

In some embodiments, the plurality of curved trajectory points are a plurality of points preset on the curved trajectory. Alternatively, the plurality of curved trajectory points are a plurality of randomly selected points on the curved trajectory, or the like. In some embodiments, some curved line segments of the curved trajectory are connected between the plurality of curved trajectory points. Lengths of the plurality of curved line segments may be the same or different. This is not limited herein.

For example, the trajectory point corresponds to the position of the master virtual object in the three-dimensional virtual environment. A position point at which the master virtual object falls on the curved trajectory may be considered as the trajectory point. Based on a case in which the master virtual object moves along a preset movement trajectory including the curved trajectory, the plurality of trajectory points may be determined based on the position point at which the master virtual object falls on the curved trajectory, and the plurality of trajectory points are points on the curved trajectory.

In an example, trajectory tangent lines respectively corresponding to the plurality of trajectory points are determined based on the curved trajectory.

For example, the trajectory tangent line is a tangent line of the trajectory point relative to the curved trajectory. Based on a case in which the tangent line is configured for representing a straight line that just touches a point on the curve, the trajectory tangent line may also be represented as: A straight line that just touches the trajectory point on the curved trajectory.

Based on a case in which the curved trajectory includes the plurality of trajectory points, a trajectory tangent line corresponding to each trajectory point may be determined based on each trajectory point and the curved trajectory, that is, a plurality of trajectory tangent lines are obtained according to the plurality of trajectory points.

In an example, the second viewing angle direction is determined based on an angle transformation status of the plurality of trajectory tangent lines, and the master virtual object is displayed in the second viewing angle direction.

For example, the plurality of trajectory tangent lines are determined based on the plurality of trajectory points. Based on a case in which the plurality of trajectory tangent lines are tangent lines determined based on the same curved trajectory, there is a transformation status between the plurality of trajectory tangent lines. That is, the transformation status of the plurality of trajectory tangent lines is determined. The transformation status includes, but is not limited to, angle transformation, position transformation, and the like.

In some embodiments, the angle transformation status is configured for describing angle transformation between the trajectory tangent lines respectively corresponding to every adjacent two of the plurality of trajectory points. For example, there are three trajectory points: a trajectory point 1, a trajectory point 2, and a trajectory point 3. A trajectory tangent line a corresponding to the trajectory point 1, a trajectory tangent line b corresponding to the trajectory point 2, and a trajectory tangent line c corresponding to the trajectory point 3 are determined. Therefore, when angle transformation statuses of the plurality of trajectory tangent lines are determined, angle transformation A between the trajectory tangent line a and the trajectory tangent line b is determined, angle transformation B between the trajectory tangent line b and the trajectory tangent line c is determined, and the angle transformation A and the angle transformation B are determined as angle transformation statuses between the three trajectory tangent lines. Alternatively, the angle transformation A and the angle transformation B are combined to determine angle transformation statuses corresponding to the three trajectory tangent lines.

In some embodiments, when the second viewing angle direction is determined based on angle transformation statuses of the plurality of trajectory tangent lines, the plurality of trajectory tangent lines are respectively used as parallel line references, and angle transformation of each of the plurality of trajectory tangent lines is used as an angle reference. When a straight line on which the observation point is located is parallel to the plurality of trajectory tangent lines, the second viewing angle direction represented by the observation point is determined by using the angle transformation between the trajectory tangent lines as angle transformation between the observation points. That is, the second viewing angle direction is a direction accompanying transformation of the trajectory tangent lines.

For example, a trajectory tangent line is determined in real time based on the curved trajectory and the master virtual object, to determine the second viewing angle direction in real time, observe the master virtual object in the second viewing angle direction, and display the master virtual object observed in the second viewing angle direction.

In other words, in the foregoing process of determining the second viewing angle direction, a trajectory tangent line at a trajectory point is introduced to determine that the master virtual object is displaced in the longitudinal direction, namely, the z-axis. The trajectory tangent line corresponding to the trajectory point is used, so that quantitative analysis can be performed on the second viewing angle direction, and the second viewing angle direction can be determined in real time in a more targeted and accurate manner. When the curved trajectory is known, a position at which and a direction in which the master virtual object is observed are determined more timely based on the master virtual object. While use experience of the player is improved, efficiency of observing the master virtual object and authenticity of picture display are greatly improved.

In some examples, the master virtual object is observed by using the virtual camera, and a picture captured by the virtual camera is displayed as the three-dimensional virtual scene.

In some embodiments, an example in which the virtual camera is oriented toward the master virtual object and the virtual camera is in a specific range from the master virtual object is used for description. For example, a center of the virtual camera and a center of the master virtual object are on a same horizontal line. During the movement of the master virtual object, a distance between the virtual camera and the master virtual object may remain unchanged, or may be changed in a preset transformation range. This is not limited in this disclosure.

In an example, based on the angle transformation statuses of the plurality of trajectory tangent lines, an observation direction of the virtual camera and the trajectory tangent lines are controlled to be perpendicular to each other, and the second viewing angle direction is obtained.

For example, there is relative angle transformation between the plurality of trajectory tangent lines, and the observation direction of the virtual camera configured for observing the master virtual object is represented based on the second viewing angle direction. Therefore, when the second viewing angle direction is determined, the direction in which the virtual object is observed is controlled in real time to be respectively perpendicular to the plurality of trajectory tangent lines, so that a plurality of observation directions corresponding to the virtual camera are flexibly adjusted based on the plurality of trajectory tangent lines, and the plurality of observation directions are collectively referred to as the second viewing angle direction. For example, sequential changes in the plurality of observation directions are collectively referred to as the second viewing angle direction.

The foregoing describes content of controlling the observation direction of the virtual camera and the trajectory tangent lines to be perpendicular to each other to determine the second viewing angle direction. The observation direction of the virtual camera is flexibly adjusted based on the angle transformation between the trajectory tangent lines respectively corresponding to the plurality of trajectory points and a set relationship that the direction and the trajectory tangent lines are perpendicular to each other, so that the plurality of trajectory tangent lines and the plurality of corresponding observation directions are combined, to obtain the second viewing angle direction that is more realistic and flexibly transformed with the trajectory tangent line. This improves observation accuracy in the second viewing angle direction, and further improves authenticity of a picture showing that the master virtual object moves on the curved trajectory.

In an example, during the movement of the master virtual object, distances between the virtual camera and the trajectory tangent lines of the plurality of trajectory points are controlled to meet a preset distance condition while the observation direction of the virtual camera and the plurality of trajectory tangent lines are controlled to be perpendicular to each other.

For example, the preset distance condition is a predetermined distance condition. In some embodiments, the preset distance condition is a fixed distance. For example, distances between the plurality of trajectory points and the virtual camera are fixed. Alternatively, the preset distance condition is in a specific distance range. For example, distances between the plurality of trajectory points and the virtual camera are in a preset interval.

In some embodiments, while the observation direction of the virtual camera and the plurality of trajectory tangent lines are controlled to be perpendicular to each other, straight line distances between the virtual camera and the plurality of trajectory points are detected in real time, or straight line distances between the virtual camera and the trajectory tangent lines of the plurality of trajectory points are detected in real time, and the straight line distances are controlled to meet the preset distance condition. For example, while the observation direction of the virtual camera and the plurality of trajectory tangent lines are controlled to be perpendicular to each other, the straight line distances between the virtual camera and the plurality of trajectory points are controlled to be maintained at a preset distance of 1 meter in real time, or the like.

In addition to limiting that the observation direction of the virtual camera is perpendicular to the trajectory tangent line, the foregoing content further limits a distance condition between the virtual camera and the trajectory tangent line (or the trajectory point), so that a position of the virtual camera is more comprehensively located from two factors: a direction and a distance. This improves precision of the movement process of the virtual camera, facilitates determining, by the virtual camera, the second viewing angle direction with higher accuracy, and improves a display effect of the master virtual object.

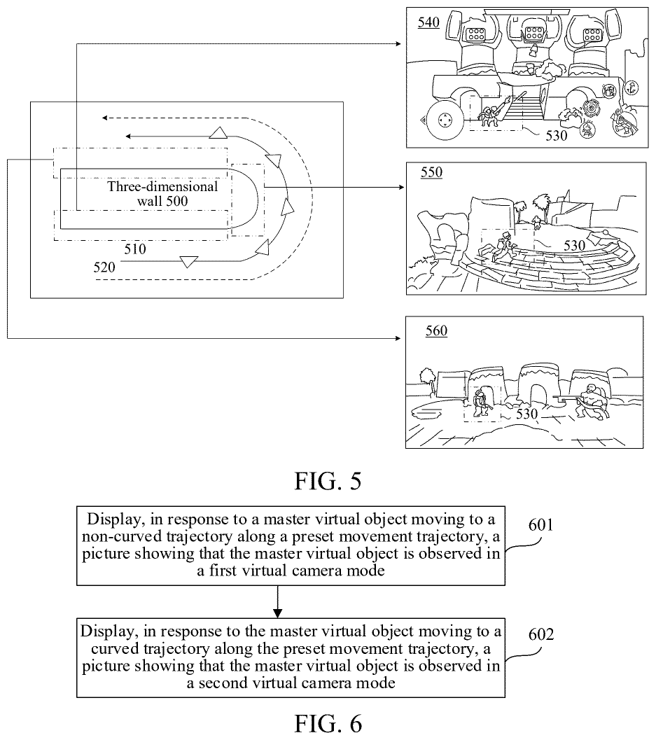

In some examples, a movement trajectory of the master virtual object in the three-dimensional virtual environment may be set according to an outer contour of three-dimensional virtual resources in the three-dimensional virtual environment. An edge on which the master virtual object moves is the outer contour of the three-dimensional virtual resources, and the master virtual object may freely move in an empty area on a peripheral side of the outer contour of the three-dimensional virtual resources. In some embodiments, the master virtual object may also move through the inside of the three-dimensional virtual resources. This is not limited in this disclosure. As shown in FIG. 5, a three-dimensional virtual environment includes a three-dimensional wall 500. The three-dimensional wall is in a U-shaped structure. A preset movement trajectory corresponding to a master virtual object 530 around the three-dimensional wall is a U-shaped trajectory 510 (a solid line trajectory in FIG. 5). A field of view obtaining trajectory of the master virtual object 530 around the three-dimensional wall 500 obtained by a virtual camera is a U-shaped trajectory 520 (a dashed line trajectory in FIG. 5). It may be learnt that, both the movement trajectory 510 of the master virtual object 530 and the field of view obtaining trajectory 520 of the virtual camera are U-shaped trajectories. The U-shaped trajectory includes two horizontal trajectories and one arc-shaped trajectory. When the master virtual object 530 moves to the horizontal trajectory, the virtual camera observes the master virtual object 530 in a first viewing angle direction, and displays a corresponding three-dimensional virtual environment picture 540. When moving on the horizontal trajectory, the master virtual object 530 may move upward and downward or leftward and rightward, and during the movement, the field of view obtaining trajectory of the virtual camera also performs translation transformation. When the master virtual object 530 moves to the arc-shaped trajectory (a curved trajectory), the master virtual object 530 is observed by switching the first viewing angle direction to a second viewing angle direction. For details, refer to a virtual environment interface 550.

Operation 202: Restore, in response to the master virtual object leaving the curved trajectory to a non-curved trajectory, the displaying of the master virtual object in the first viewing angle direction.

In some embodiments, when the master virtual object moves from the curved trajectory to the non-curved trajectory, the displaying of the master virtual object in the first viewing angle direction is restored in the second viewing angle direction. As shown in FIG. 5, when the master virtual object 530 moves from the arc-shaped trajectory to a horizontal trajectory, the master virtual object 530 is observed by switching a rotation viewing angle to the first viewing angle direction. For details, refer to a virtual environment interface 560.

In summary, according to the virtual environment display method provided in the embodiments of this disclosure, in a process in which the master virtual object moves according to the preset movement trajectory in the three-dimensional virtual environment, when the master virtual object passes through a curved trajectory of the preset movement trajectory, the first viewing angle direction in which the master virtual object is observed along the non-curved trajectory is switched to the second viewing angle direction in which the master virtual object is observed through synchronous rotation along the curved trajectory. In addition, when the master virtual object passes through a non-curved trajectory of the preset movement trajectory, the master virtual object is observed by flexibly switching the second viewing angle direction to the first viewing angle direction. A viewing angle of observing the master virtual object is switched, so that flexibility of controlling the master virtual object can be improved, and a movement status of the master virtual object in the three-dimensional virtual environment can be vividly presented. More visual experiences are created according to the fixedly set preset movement trajectory, and the visual experiences are presented in a three-dimensional form. This further improves a visual impact effect on a user in a side-scrolling game, and improves interface expression of the three-dimensional virtual environment.

In the embodiments of this disclosure, the second viewing angle direction is determined by using transformation statuses of trajectory tangent lines corresponding to a plurality of trajectory points in the three-dimensional virtual environment, and the master virtual object moving on the curved trajectory is observed in the second viewing angle direction, to ensure visual stability of the observation of the master virtual object to some extent, and improve an interface switching effect.

In the embodiments of this disclosure, to ensure that the master virtual object does not leave an observation body, both a preset virtual camera and a rotating virtual camera maintain a preset distance from the master virtual object when observing the master virtual object. This improves smoothness of picture display to a certain extent, and improves efficiency of displaying the master virtual object and the three-dimensional virtual object.

FIG. 6 is a flowchart of a virtual environment display method according to an example of this disclosure. The method includes:

Operation 601: Display, in response to a master virtual object moving to a non-curved trajectory along a preset movement trajectory, a picture showing that the master virtual object is observed in a first virtual camera mode.

It may be learned from the foregoing that, the master virtual object is observed by using a virtual camera. The virtual camera includes the first virtual camera mode and a second virtual camera mode. In different virtual camera modes, the master virtual object is observed from different viewing angles. The first virtual camera mode is configured for indicating to observe the master virtual object in a first viewing angle direction, and the second virtual camera mode is configured for indicating to observe the master virtual object in a second viewing angle direction. In embodiments of this disclosure, the first virtual camera mode is implemented as a preset virtual camera, and the preset virtual camera is configured to observe the master virtual object in the first viewing angle direction. That is, the first viewing angle direction is a direction in which observation is performed through the preset virtual camera.

In some embodiments, when the master virtual object moves to the non-curved trajectory, a picture showing that the master virtual object is observed in the first virtual camera mode is displayed. In the first virtual camera mode, the master virtual object is observed mainly in a translation viewing angle direction, and the translation viewing angle direction varies with a movement direction of the master virtual object in a three-dimensional virtual environment.

In an example, position coordinates of the master virtual object in a three-dimensional virtual scene are determined in response to the master virtual object moving along the non-curved trajectory in a movement trajectory.

For example, the position coordinates are configured for representing position information of the master virtual object in the three-dimensional virtual scene. When the master virtual object moves along the non-curved trajectory in the movement trajectory, the position coordinates of the master virtual object in the three-dimensional virtual scene are determined in real time, and at least one pair of position coordinates corresponding to the master virtual object may be obtained.

In an example, camera coordinates of a virtual camera configured for observing the master virtual object are determined based on the position coordinates and a preset observation coordinate difference.

The preset observation coordinate difference represents a direction deviation and a distance deviation of relative position coordinates of the virtual camera.

For example, on a condition that the position coordinates are known, the position coordinates are adjusted according to the preset observation coordinate difference, to determine the camera coordinates of the virtual camera, and the camera coordinates are configured for representing the position information of the virtual camera in the three-dimensional virtual scene.

In some embodiments, when the master virtual object corresponds to a plurality of position coordinates, camera coordinates respectively corresponding to each pair of position coordinates are determined, and the plurality of camera coordinates are configured for observing the master virtual object at the corresponding position coordinates in different observation directions.

In an example, the master virtual object is observed through the virtual camera at the camera coordinates, and the master virtual object is displayed in the first viewing angle direction in the three-dimensional virtual scene.

For example, after the position coordinates corresponding to the virtual camera are determined, a position of the virtual camera may be determined from the three-dimensional virtual scene, so that the virtual camera is placed at the corresponding position of the camera, and a purpose of observing the master virtual object through the virtual camera is achieved, so that the master virtual object in the three-dimensional virtual scene is displayed in the first viewing angle direction.

The foregoing content describes a method for determining the first viewing angle direction on the non-curved trajectory. The position coordinates of the master virtual object are adjusted by using the preset observation coordinate difference, to determine the camera coordinates of the virtual camera configured for observing the master virtual object. The camera coordinates represent the position of the camera when the master virtual object is observed. In this way, the position of the virtual camera can be limited, observation accuracy of the virtual camera can be improved, and accuracy of the first viewing angle direction can be improved. In addition, observation stability can be further properly limited by using the preset observation coordinate difference, and picture display stability can be improved.

Operation 602: Display, in response to the master virtual object moving to the curved trajectory along the preset movement trajectory, a picture showing that the master virtual object is observed in the second virtual camera mode.

When the master virtual object moves out of the non-curved trajectory to the curved trajectory, the picture showing that the master virtual object is observed in the second virtual camera mode is displayed. In the second virtual camera mode, the master virtual object is observed mainly in the second viewing angle direction, and the second viewing angle direction varies with the movement direction of the master virtual object in the three-dimensional virtual environment. In the embodiments of this disclosure, the second virtual camera mode is implemented as a rotating virtual camera, and the rotating virtual camera is configured to observe the master virtual object in the second viewing angle direction.

That is, the preset virtual camera is switched to a rotating virtual camera in response to the master virtual object moving to the curved trajectory along the preset movement trajectory. The master virtual object is observed in the second viewing angle direction through the rotating virtual camera.

For example, the first viewing angle direction and the second viewing angle direction are divided by using the preset virtual camera and the rotating virtual camera. This facilitates smoother display of the movement process of the master virtual object on the non-curved trajectory by using the preset virtual camera, and improves picture smoothness. As the master virtual object moves from the non-curved trajectory to the curved trajectory, to display a picture effect more vividly, the preset virtual camera focusing on displaying a smooth effect is switched to the rotating virtual camera, so that the master virtual object on the curved trajectory displays the curved line movement status in a more three-dimensional manner through the rotating virtual camera. In this way, picture change statuses in different trajectory statuses are more differentially displayed by using the rotating virtual camera and the preset virtual camera. This improves realness of picture display, enriches the picture effect, and also achieves an objective of flexible data processing by using flexible switching of the virtual cameras.

For specific operations, refer to the foregoing operation 201. Details are not described herein again.

In an example, when the curved trajectory includes a circular trajectory, in response to the master virtual object moving to the circular trajectory, a circle center position of the circular trajectory is determined; and the second viewing angle direction is determined based on the circle center position and the master virtual object.

For example, when the curved trajectory is implemented as the circular trajectory, a process in which the master virtual object moves along the curved trajectory may be considered as a process in which the master virtual object moves surrounding a circle center of the circular trajectory. Based on this, when the curved trajectory is implemented as the circular trajectory, the circle center position of the circular trajectory is determined, and then the second viewing angle direction is determined based on the circle center position and the master virtual object.

In some embodiments, the circular trajectory corresponds to an outer contour of a circular virtual object. When the circle center position of the circular trajectory is determined, it means that a circle center of the circular virtual object is determined.

By means of a symmetric characteristic of the circular trajectory, a circle center implemented as a symmetric center point is determined, so that the reference position at which the master virtual object performs surrounding movement can be analyzed in a targeted manner, and the circle center and the master virtual object can be combined, which facilitates a more targeted understanding of an observation status of the virtual camera configured to determine the second viewing angle direction, to obtain the second viewing angle direction with higher observation accuracy, and improve realness of a picture showing that the master virtual object is observed based on the second viewing angle direction.

In the embodiments of this disclosure, when the master virtual object is observed, the circle center position, the master virtual object, and the virtual camera are controlled to be located on a same straight line, to determine a second viewing angle direction corresponding to the virtual camera.

For example, a circle center corresponding to the circular trajectory represents a reference point at which the master virtual object performs surrounding movement. After the circle center position is determined, the circle center position, an object position corresponding to the master virtual object, and a camera position corresponding to the virtual camera may be connected as a straight line. The circle center position is unchanged in the circular trajectory, and the object position of the master virtual object varies with the movement process along the circular trajectory. If the circle center position, the master virtual object, and the virtual camera are located on a straight line, the virtual camera varies with the master virtual object. Therefore, the second viewing angle direction is determined based on the virtual camera.

In the foregoing content, the position of the virtual camera is flexibly adjusted based on a constant characteristic of the circle center position on the circular trajectory, and a limitation that the change of the movement position of the master virtual object and the fixed position of the circle center position are on the same straight line. A trajectory shape characteristic of the curved trajectory is fully used, and efficiency of determining the position of the virtual camera is improved, so that the second viewing angle direction of the virtual camera can be learned more quickly, and an amount of data processing in the process of determining the second viewing angle direction is reduced, to display a picture special effect more efficiently and realistically.

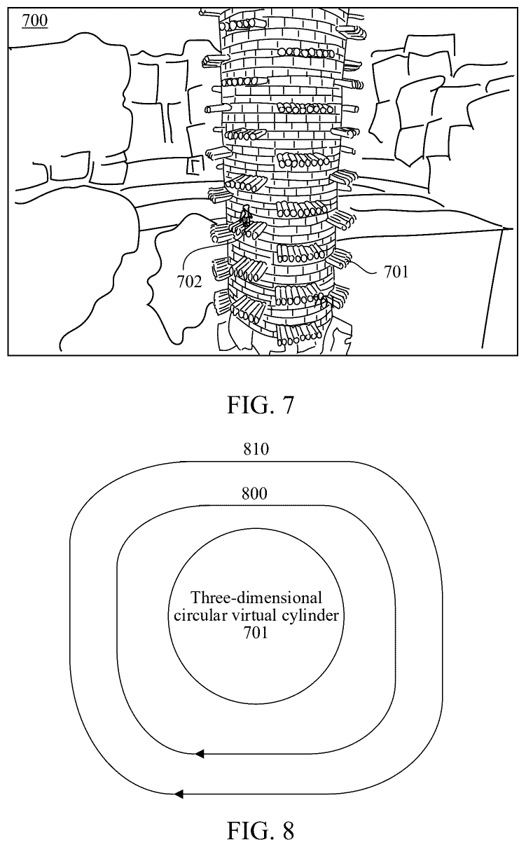

As shown in FIG. 7, in a three-dimensional virtual environment interface 700, there is a three-dimensional circular virtual cylinder 701, and a player controls a master virtual object 702 to move in different directions surrounding the three-dimensional circular virtual cylinder 701. For a movement trajectory of the master virtual object, refer to an elliptical trajectory 800 in FIG. 8. For a field of view obtaining trajectory of a virtual camera surrounding the master virtual object, refer to the elliptical trajectory 810 in FIG. 8. During rotational movement of the master virtual object, the elliptical trajectory is formed by a combination of a straight line trajectory and a curved trajectory. On the straight line trajectory, the master virtual object is still observed by using a preset virtual camera, and on the curved trajectory, the master virtual object is observed by using a rotating virtual camera. A movement line on which a player controls the master virtual object to be in the three-dimensional virtual environment is circular, and a camera trajectory of the virtual camera following the master virtual object is also circular. Therefore, when the master virtual object walks on the movement line, the virtual camera always remains in a rotating state. During setting, a line formed by a center of the camera, a position of the master virtual object, and a circle center of a circle can form a three-dimensional experience with a high visual impact that is both side-scrolling and rotational.

In an example, a connecting line between a center of the virtual camera and the master virtual object is determined when the master virtual object moves along the curved trajectory; and the connecting line and the curved trajectory are controlled to maintain a mutually perpendicular relationship.

For example, the connecting line between the center of the virtual camera and the master virtual object is used as a reference, and an angle between the connecting line and the curved trajectory is adjusted in real time, so that the connecting line and the curved trajectory maintain perpendicular to each other at any moment, to achieve an objective that a movement angle of the virtual camera changes in real time with a curved angle of the curved trajectory, and improve positioning accuracy of the virtual camera.

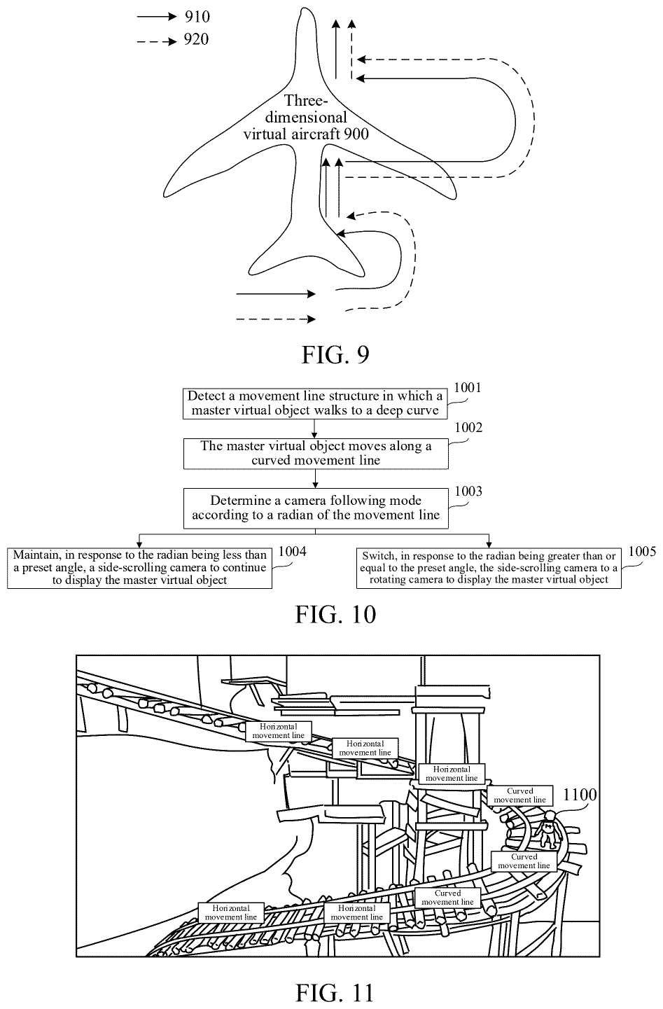

In an example, a preset movement trajectory of the master virtual object is an irregular trajectory. The irregular trajectory is also formed by a combination of a straight line trajectory and the curved trajectory. As shown in FIG. 9, the master virtual object moves surrounding a three-dimensional virtual aircraft 900. A movement trajectory is shown as a solid line trajectory 910 shown in FIG. 9. A movement trajectory captured by the virtual camera on the master virtual object is shown as a dashed line trajectory 920 shown in FIG. 9. A preset virtual camera is used at a horizontal position, and a rotating virtual camera is used on the curved trajectory.

In an example, when the master virtual object is in a fighting state, the master virtual object fires a virtual round to attack another virtual object or throws a virtual ammunition to attack another virtual object, and the virtual camera observes the three-dimensional virtual environment based on a firing trajectory of the virtual round/the virtual ammunition. In some embodiments, the master virtual object may further attack the virtual object by using other virtual resources. This is not limited in this disclosure.

In some embodiments, the firing trajectory also includes the curved trajectory and the non-curved trajectory. When the firing trajectory is the curved trajectory, the virtual round/virtual ammunition is observed in the second viewing angle direction by using the rotating virtual camera. When the firing trajectory is the non-curved trajectory, the virtual round/virtual ammunition is observed in the first viewing angle direction by using the preset virtual camera. In some embodiments, the firing trajectory may include both the curved trajectory and the non-curved trajectory. When connection is made between the curved trajectory and the non-curved trajectory, an observation mode corresponding to the virtual camera changes accordingly.

In an example, when the master virtual object performs interaction in the three-dimensional virtual environment, an observation scale of the virtual camera is determined according to an interaction type. The observation scale is configured for indicating that the three-dimensional virtual environment centered on the master virtual object is displayed at a preset size (preset picture scale). The interaction type includes at least one of walking interaction, pickup interaction, attack interaction, defense interaction, and chase interaction. Different interaction types correspond to different observation scales. In a process in which the player controls the master virtual object to perform a battle, a virtual interface is zoomed in and out to implement a diversity-rich visual experience.

In summary, according to the virtual environment display method provided in the embodiments of this disclosure, in a process in which the master virtual object moves according to the preset movement trajectory in the three-dimensional virtual environment, when the master virtual object passes through a curved trajectory of the preset movement trajectory, the first viewing angle direction in which the master virtual object is observed along a non-curved trajectory is switched to the second viewing angle direction in which the master virtual object is observed through synchronous rotation along the curved trajectory. In addition, when the master virtual object passes through a non-curved trajectory of the preset movement trajectory, the master virtual object is observed by flexibly switching the second viewing angle direction to the first viewing angle direction. A viewing angle of observing the master virtual object is switched, so that flexibility of controlling the master virtual object can be improved, and a movement status of the master virtual object in the three-dimensional virtual environment can be vividly presented. More visual experiences are created according to the fixedly set preset movement trajectory, and the visual experiences are presented in a three-dimensional form. This further improves a visual impact effect on a user in a side-scrolling game, and improves interface expression of the three-dimensional virtual environment.

In the embodiments of this disclosure, corresponding following virtual cameras are set for different movement trajectories. That is, on the non-curved trajectory, the preset virtual camera is set to observe the master virtual object, and on the curved trajectory, the rotating virtual camera is set to observe the master virtual object. Because the movement trajectory of the master virtual object is set in advance, when the master virtual object walks to a corresponding trajectory, a corresponding following virtual camera is directly invoked or switched to observe an interaction behavior of the master virtual object in the three-dimensional virtual environment. This improves smoothness of switching of a user interface during trajectory switching to some extent, and avoids stuttering of pictures.

In the embodiments of this disclosure, when the curved trajectory is implemented as the circular trajectory, a field of view obtaining trajectory of the rotating virtual camera is consistent with the circular trajectory, and the rotating virtual camera is always oriented toward the master virtual object. A visual effect that the rotating virtual camera also rotates with the rotation of the master virtual object is implemented, to improve a visual impact on the player.

FIG. 10 is a flowchart of a virtual environment display method according to an example of this disclosure. The method includes:

Operation 1001: Detect a movement line structure in which a master virtual object walks to a deep curve.

In embodiments of this disclosure, when the master virtual object moves along a preset movement trajectory, a terminal detects whether there is a curved movement line on a current movement trajectory. The curved movement line is configured for indicating that the master virtual object has a movement component in a longitudinal direction, namely, a z-axis. As shown in FIG. 11, during movement of a master virtual object 1100, the preset movement trajectory is a trajectory shown in FIG. 11. During movement of the master virtual object 1100, the terminal detects a movement component corresponding to each trajectory point. When there is a preset angle between a trajectory tangent line corresponding to the trajectory point and a horizontal direction, namely, an x-axis, the terminal determines a trajectory point corresponding to the master virtual object 1100 to move to a movement line structure. The movement line structure is consistent with meaning of the curved trajectory mentioned above.

Operation 1002: The master virtual object moves along the curved movement line.

In the embodiments of this disclosure, a player controls the master virtual object to move along the curved movement line. In some embodiments, because a game category in this application is a side-scrolling virtual game, during a virtual battle, a movement trajectory of the master virtual object is usually preset, and virtual camera switching or viewing angle switching mentioned in the foregoing embodiments needs to be triggered at a start point of the curved movement line.

In some embodiments, during the movement of the master virtual object, an orientation of a face of the master virtual object is always toward a tangent line direction of the preset movement trajectory.
Step 1003: Determine a camera following mode according to a radian of the movement line.

In this embodiments of this disclosure, when the master virtual object moves to the start point of the movement line, it is determined whether an angle between a trajectory tangent line corresponding to the start point and a horizontal direction falls within a preset angle, and the radian of the movement line is determined according to a determining result, where different radians correspond to different virtual cameras.

If the radian is less than the preset angle, operation 1004 is performed. If the radian is greater than or equal to the preset angle, operation 1005 is performed.

Operation 1004: Maintain, in response to the radian being less than the preset angle, a side-scrolling camera to continue to display the master virtual object.

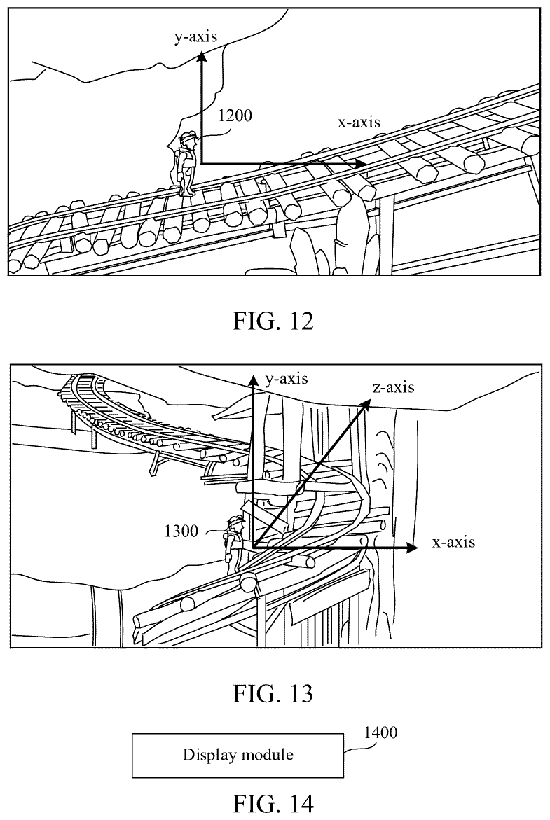

In some embodiments, when the radian of the movement line structure is less than the preset angle, the master virtual object is observed by using the side-scrolling camera (the preset virtual camera mentioned above). Under the movement line structure, it may be considered that the master virtual object only moves in a horizontal direction, namely, an x-axis and a vertical direction, namely, a y-axis. Specifically, as shown in FIG. 12, under the side-scrolling camera, the master virtual object 1200 only moves in the x-axis and the y-axis. A process of observing the master virtual object through the side-scrolling camera is the first viewing angle direction in which the master virtual object is observed.
Step 1005: Switch, in response to the radian being greater than or equal to the preset angle, the side-scrolling camera to a rotating camera to display the master virtual object.

In some embodiments, when the radian of the movement line structure is greater than or equal to the preset angle, the master virtual object is observed by using the rotating camera (the foregoing rotating virtual camera). Under the movement line structure, the master virtual object moves in the longitudinal direction, namely, the z-axis. With the movement of the z-axis, the master virtual object moves in the horizontal direction, namely, the x-axis and the vertical direction, namely, the y-axis. Specifically, as shown in FIG. 13, under the rotating camera, the master virtual object 1300 simultaneously moves in the x-axis, the y-axis, and the z-axis, that is, the master virtual object 1300 has movement components in the x-axis, the y-axis, and the z-axis.

In some embodiments, in operation 1004 and operation 1005, according to the camera following mode, a corresponding camera mode is switched based on the arc of the movement structure, and movement is performed following the master virtual object.

In the embodiments of this disclosure, to maintain characteristics of the side-scrolling virtual game, when the rotating camera performs photographing and observation on the master virtual object, a connecting line between a center of the virtual camera and the master virtual object and the preset movement trajectory are maintained to be perpendicular to each other, so that a visual effect of the side-scrolling virtual game can be effectively implemented. A process of observing the master virtual object through the rotating camera is the second viewing angle direction in which the master virtual object is observed.

In other words, in the side-scrolling game, a 3D visual effect is increased, and a game experience and a sense of immersion of the player are improved by using three-dimensional aesthetic resources, a movement line corresponding to the longitudinal direction, namely, the z-axis, and a rotating virtual object while preserving a fast-pace fight of the original side-scrolling game.

In summary, according to the virtual environment display method provided in the embodiments of this disclosure, based on the three-dimensional virtual environment, in a process in which the master virtual object moves according to the preset movement trajectory in the three-dimensional virtual environment, when the master virtual object passes through a curved trajectory of the preset movement trajectory, the first viewing angle direction in which the master virtual object is observed along a non-curved trajectory is switched to the second viewing angle direction in which the master virtual object is observed through synchronous rotation along the curved trajectory. In addition, when the master virtual object passes through a non-curved trajectory of the preset movement trajectory, the master virtual object is observed by flexibly switching the second viewing angle direction to the first viewing angle direction. A viewing angle of observing the master virtual object is switched, so that flexibility of controlling the master virtual object can be improved, and a movement status of the master virtual object in the three-dimensional virtual environment can be vividly presented. More visual experiences are created according to the fixedly set preset movement trajectory, and the visual experiences are presented in a three-dimensional form. This further improves a visual impact effect on a user in the side-scrolling game, and improves interface expression of the three-dimensional virtual environment.

In the embodiments of this disclosure, it is determined in real time whether the master virtual object has a displacement component in the longitudinal direction at a current position during movement, and an observation manner in which the master virtual object is observed by using the virtual camera is determined according to the determining result, to further improve the game experience and the sense of immersion of the player.

FIG. 14 is a structural block diagram of a virtual environment display apparatus according to an example of this disclosure. The apparatus includes:

a display module 1400, configured to display a master virtual object in a three-dimensional virtual scene in a first viewing angle direction, the master virtual object moving along a preset movement trajectory in the three-dimensional virtual scene, the preset movement trajectory including a curved trajectory and a non-curved trajectory, and the first viewing angle direction being a relative observation direction in which the master virtual object is observed along the non-curved trajectory;

the display module 1400 being further configured to display the master virtual object in a second viewing angle direction in response to the master virtual object moving to the curved trajectory along the preset movement trajectory, the second viewing angle direction being a relative observation direction in which the master virtual object is observed through synchronous rotation along the curved trajectory; and

the display module 1400 being further configured to restore, in response to the master virtual object leaving the curved trajectory to the non-curved trajectory, the displaying of the master virtual object in the first viewing angle direction.

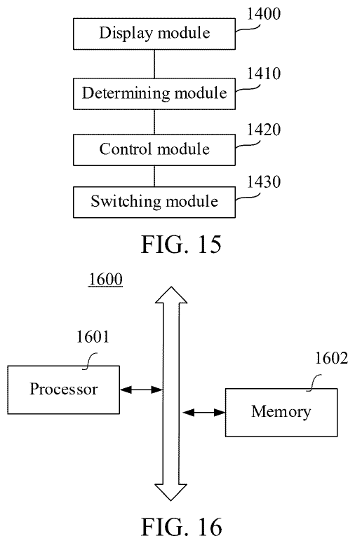

In an example, as shown in FIG. 15, the apparatus further includes:
a determining module 1410, configured to determine a plurality of trajectory points on the curved trajectory in a process in which the master virtual object moves according to the curved trajectory, where the trajectory points correspond to positions of the master virtual object in the three-dimensional virtual environment;
the determining module 1410, further configured to determine, based on the curved trajectory, trajectory tangent lines respectively corresponding to the plurality of trajectory points; and
the display module 1400, further configured to determine the second viewing angle direction based on an angle transformation status of the plurality of trajectory tangent lines, and display the master virtual object in the second viewing angle direction, where the angle transformation status is configured for describing angle transformation between the trajectory tangent lines respectively corresponding to every adjacent two of the plurality of trajectory points.

In an example, as shown in FIG. 15, the three-dimensional virtual scene is displayed through a virtual camera.

A control module 1420 is configured to control, based on the angle transformation status, an observation direction of the virtual camera and the trajectory tangent lines to be perpendicular to each other, and obtain the second viewing angle direction.

In an example, as shown in FIG. 15, the control module 1420 is further configured to control distances between the virtual camera and the trajectory tangent lines of the plurality of trajectory points to meet a preset distance condition while controlling the observation direction of the virtual camera and the plurality of trajectory tangent lines to be perpendicular to each other.

In an example, as shown in FIG. 15, the first viewing angle direction is a direction in which observation is performed through a preset virtual camera.

A switching module 1430 is configured to switch from the preset virtual camera to a rotating virtual camera in response to the master virtual object moving to the curved trajectory along the preset movement trajectory; and

the display module 1400 is further configured to observe the master virtual object in the second viewing angle direction through the rotating virtual camera.

In an example, as shown in FIG. 15, the curved trajectory includes a circular trajectory.

The determining module 1410 is further configured to determine a circle center position of the circular trajectory in response to the master virtual object moving to the circular trajectory; and

the determining module 1410 is further configured to determine the second viewing angle direction based on the circle center position and the master virtual object.

In an example, as shown in FIG. 15, the control module 1420 is further configured to control the circle center position, the master virtual object, and the virtual camera to be located on a same straight line, and determine a second viewing angle direction corresponding to the virtual camera.

In an example, the display module 1400 is further configured to determine position coordinates of the master virtual object in the three-dimensional virtual scene in response to the master virtual object moving along the non-curved trajectory in the movement trajectory; determine, based on the position coordinates and a preset observation coordinate difference, camera coordinates of a virtual camera configured to observe the master virtual object, where the preset observation coordinate difference represents a direction deviation and a distance deviation of the virtual camera relative to the position coordinates; and observe the master virtual object through the virtual camera at the camera coordinates, and display, in the first viewing angle direction, the master virtual object in the three-dimensional virtual scene.

In summary, according to the virtual environment display apparatus provided in the embodiments of this disclosure, based on the three-dimensional virtual environment, in a process in which the master virtual object moves according to the preset movement trajectory in the three-dimensional virtual environment, when the master virtual object passes through a curved trajectory of the preset movement trajectory, the first viewing angle direction in which the master virtual object is observed along a non-curved trajectory is switched to the second viewing angle direction in which the master virtual object is observed through synchronous rotation along the curved trajectory. In addition, when the master virtual object passes through a non-curved trajectory of the preset movement trajectory, the master virtual object is observed by flexibly switching the second viewing angle direction to the first viewing angle direction. A viewing angle of observing the master virtual object is switched, so that flexibility of controlling the master virtual object can be improved, and a movement status of the master virtual object in the three-dimensional virtual environment can be vividly presented. More visual experiences are created according to the fixedly set preset movement trajectory, and the visual experiences are presented in a three-dimensional form. This further improves a visual impact effect on a user in the side-scrolling game, and improves interface expression of the three-dimensional virtual environment.

The virtual environment display apparatus according to the foregoing embodiment is illustrated only with an example of division of the foregoing functional modules. The functions may be allocated to and completed by different functional modules according to requirements, that is, the internal structure of the device is divided into different functional modules, to implement all or some of the functions described above. In addition, the virtual environment display apparatus and virtual environment display method embodiments provided in the foregoing embodiments belong to one conception. For the specific implementation process, refer to the method embodiments, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 16 is a structural block diagram of a terminal 1600 according to an example of this disclosure. The terminal 1600 may be a portable mobile terminal, for example, a smartphone, a vehicle-mounted terminal, a tablet computer, a notebook computer, or a desktop computer. The terminal 1600 may be further referred to as user equipment, a portable terminal, a laptop terminal, a desktop terminal, or by another name.

Generally, the terminal 1600 includes a processor 1601 and a memory 1602.

Processing circuitry, such as the processor 1601 may include one or more processing cores, for example, a 4-core processor or an 8-core processor. The memory 1602, such as a non-transitory computer-readable storage medium, may include one or more computer-readable storage media. The computer-readable storage medium may be non-transient.

In some embodiments, the terminal 1600 may further include one or more sensors. The one or more sensors include, but are not limited to: a proximity sensor, a gyroscope sensor, and a pressure sensor.

In some embodiments, the terminal 1600 further includes other components. A person skilled in the art may understand that the structure shown in FIG. 16 does not constitute a limitation on the terminal 1600 and that the terminal 1600 may include more or fewer assemblies than those shown in the figure, a combination of some assemblies, or different assembly arrangements.

A person of ordinary skill in the art may understand that all or some of the steps of the methods in the foregoing embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and that is not assembled in a terminal. The computer-readable storage medium stores at least one instruction, at least one segment of program, a code set, or an instruction set, the at least one instruction, the at least one segment of program, the code set, or the instruction set being loaded and executed by the processor to implement the virtual environment display method according to any one of the foregoing embodiments of this disclosure.

In some embodiments, the computer-readable storage medium may include: a read-only memory (ROM), a random access memory (RAM), a solid-state drive (SSD), an optical disc, or the like. The RAM may include a resistance random access memory (ReRAM) and a dynamic random access memory (DRAM). The sequence numbers of the foregoing embodiments of this disclosure are merely for description purpose, and are not intended to indicate the preference among the embodiments.

What is claimed is:

1. A virtual environment display method, the method comprising:
displaying, by processing circuitry, a virtual object in a three-dimensional virtual scene moving along a preset trajectory, the preset trajectory including a curved trajectory and a non-curved trajectory;
displaying the virtual object in a first viewing angle direction, the first viewing angle direction being an observation direction of a first virtual camera along the non-curved trajectory;
displaying the virtual object in a second viewing angle direction when the virtual object moves to the curved trajectory, the second viewing angle direction being an observation direction of a second virtual camera along the curved trajectory; and
updating, when the virtual object switches from the curved trajectory to the non-curved trajectory, the display of the virtual object back to the first viewing angle direction.

2. The method according to claim 1, wherein the displaying the virtual object in the second viewing angle direction further comprises:
determining a plurality of trajectory points on the curved trajectory, wherein the trajectory points correspond to positions of the virtual object in the three-dimensional virtual scene;
determining, based on the curved trajectory, trajectory tangent lines respectively corresponding to the plurality of trajectory points; and
determining the second viewing angle direction based on an angle transformation status of the plurality of trajectory tangent lines, wherein the angle transformation status indicates an angle transformation between the trajectory tangent lines of two adjacent trajectory points of the plurality of trajectory points.

3. The method according to claim 2, wherein the determining the second viewing angle direction further comprises:
controlling, based on the angle transformation status, the second virtual camera in a position such that an observation direction of the virtual camera is perpendicular to the trajectory tangent line; and
obtaining the second viewing angle direction based on the position of the second virtual camera.

4. The method according to claim 3, wherein the controlling the second virtual camera further comprises:
controlling the second virtual camera and the trajectory tangent lines of the plurality of trajectory points to maintain a minimum distance, the observation direction of the second virtual camera being perpendicular to the plurality of trajectory tangent lines respectively.

5. The method according to claim 1, wherein
the first virtual camera is a preset virtual camera;
the second virtual camera is a rotating virtual camera; and
the displaying the virtual object in the second viewing angle direction further comprises:
switching from the preset virtual camera to the rotating virtual camera when the virtual object moves along the curved trajectory; and
displaying the virtual object in the second viewing angle direction based on the observation direction of the rotating virtual camera.

6. The method according to claim 1, wherein
the curved trajectory includes a circular trajectory; and
the displaying the virtual object in the second viewing angle direction further comprises:
determining a circle center position of the circular trajectory when the virtual object moves to the circular trajectory; and
determining the second viewing angle direction based on the circle center position and a position of the virtual object.

7. The method according to claim 6, wherein the determining the second viewing angle direction based on the circle center position and the position of the virtual object further comprises:
controlling the circle center position, the virtual object, and the observation direction of the second virtual camera to be located on a straight line.

8. The method according to claim 7, wherein the method further comprises:
determining a connecting line between a center of the virtual camera and the virtual object when the virtual object moves along the curved trajectory; and
controlling the connecting line and the curved trajectory to maintain a mutually perpendicular relationship.

9. The method according to claim 1, wherein the displaying the virtual object in the three-dimensional virtual scene further comprises:
determining position coordinates of the virtual object in the three-dimensional virtual scene when the virtual object moves along the non-curved trajectory;
determining, based on the position coordinates and a preset observation coordinate difference, camera coordinates of the first virtual camera that is configured to observe the virtual object, wherein the preset observation coordinate difference represents a direction deviation and a distance deviation of the first virtual camera relative to the position coordinates; and
displaying the virtual object in the first viewing angle direction from the observation direction of the first virtual camera at the camera coordinates.

10. An information processing apparatus, comprising:
processing circuitry configured to:
display a virtual object in a three-dimensional virtual scene moving along a preset trajectory, the preset trajectory includes a curved trajectory and a non-curved trajectory;
display the virtual object in a first viewing angle direction, the first viewing angle direction is an observation direction of a first virtual camera along the non-curved trajectory;
display the virtual object in a second viewing angle direction when the virtual object moves to the curved trajectory, the second viewing angle direction is an observation direction of a second virtual camera along the curved trajectory; and
update, when the virtual object switches from the curved trajectory to the non-curved trajectory, the display of the virtual object back to the first viewing angle direction.

11. The information processing apparatus according to claim 10, wherein the processing circuitry is further configured to:
determine a plurality of trajectory points on the curved trajectory, wherein the trajectory points correspond to positions of the virtual object in the three-dimensional virtual scene;
determine, based on the curved trajectory, trajectory tangent lines corresponding to the plurality of trajectory points respectively; and
determine the second viewing angle direction based on an angle transformation status of the plurality of trajectory tangent lines, wherein the angle transformation status indicates an angle transformation between the trajectory tangent lines of two adjacent trajectory points of the plurality of trajectory points.

12. The information processing apparatus according to claim 11, wherein the processing circuitry is further configured to:
control, based on the angle transformation status, the second virtual camera in a position such that an observation direction of the virtual camera is perpendicular to the trajectory tangent line; and
obtain the second viewing angle direction based on the position of the second virtual camera.

13. The information processing apparatus according to claim 12, wherein the processing circuitry is further configured to:
control the second virtual camera and the trajectory tangent lines of the plurality of trajectory points to maintain a minimum distance, the observation direction of the second virtual camera being perpendicular respectively to the plurality of trajectory tangent lines.

14. The information processing apparatus according to claim 10, wherein
the first virtual camera is a preset virtual camera;
the second virtual camera is a rotating virtual camera; and
the processing circuitry is further configured to:
switch from the preset virtual camera to the rotating virtual camera when the virtual object moves along the curved trajectory; and
display the virtual object in the second viewing angle direction based on the observation direction of the rotating virtual camera.

15. The information processing apparatus according to claim 10, wherein
the curved trajectory includes a circular trajectory; and
the processing circuitry is further configured to:
determine a circle center position of the circular trajectory when the virtual object moves to the circular trajectory; and
determine the second viewing angle direction based on the circle center position and a position of the virtual object.

16. A non-transitory computer-readable storage medium, storing instructions which when executed by a processor cause the processor to perform:
displaying a virtual object in a three-dimensional virtual scene moving along a preset trajectory, the preset trajectory including a curved trajectory and a non-curved trajectory;
displaying the virtual object in a first viewing angle direction, the first viewing angle direction being an observation direction of a first virtual camera along the non-curved trajectory;
displaying the virtual object in a second viewing angle direction when the virtual object moves to the curved trajectory, the second viewing angle direction being an observation direction of a second virtual camera along the curved trajectory; and
updating, when the virtual object switches from the curved trajectory to the non-curved trajectory, the display of the virtual object back to the first viewing angle direction.

17. The non-transitory computer-readable storage medium according to claim 16, wherein the instructions when executed by the processor further cause the processor to perform:
determining a plurality of trajectory points on the curved trajectory, wherein the trajectory points correspond to positions of the virtual object in the three-dimensional virtual scene;
determining, based on the curved trajectory, trajectory tangent lines respectively corresponding to the plurality of trajectory points; and
determining the second viewing angle direction based on an angle transformation status of the plurality of trajectory tangent lines, wherein the angle transformation status indicates an angle transformation between the trajectory tangent lines of two adjacent trajectory points of the plurality of trajectory points.

18. The non-transitory computer-readable storage medium according to claim 17, wherein the instructions when executed by the processor further cause the processor to perform:
controlling, based on the angle transformation status, the second virtual camera in a position such that an observation direction of the virtual camera is perpendicular to the trajectory tangent line; and
obtaining the second viewing angle direction based on the position of the second virtual camera.

19. The non-transitory computer-readable storage medium according to claim 18, wherein the instructions when executed by the processor further cause the processor to perform:
controlling the second virtual camera and the trajectory tangent lines of the plurality of trajectory points to maintain a minimum distance, the observation direction of the second virtual camera being perpendicular respectively to the plurality of trajectory tangent lines.

20. The non-transitory computer-readable storage medium according to claim 16, wherein
the first virtual is a preset virtual camera;
the second virtual camera is a rotating virtual camera; and
the instructions when executed by the processor further cause the processor to perform:
switching from the preset virtual camera to the rotating virtual camera when the virtual object moves along the curved trajectory; and
displaying the virtual object in the second viewing angle direction based on the observation direction of the rotating virtual camera.
